(19) United States
(12) Patent Application Publication
(10) Pub. No.: US 2015/0070954 A1
(43) Pub. Date: Mar. 12, 2015

(54) CONTROLLER HAVING ADJUSTABLE FREQUENCY-REDUCTION FUNCTION AND SYSTEM USING SAME

(71) Applicant: Zentel Electronics Corp., Hsinchu (TW)

(72) Inventors: Jun Hsiung HUANG, Hsinchu (TW); Yu Wen CHANG, Hsinchu (TW)

(73) Assignee: Zentel Electronics Corp., Hsinchu (TW)

(21) Appl. No.: 14/020,482

(22) Filed: Sep. 6, 2013

(51) Int. Cl. H02M 7/217

(52) U.S. Cl. CPC H02M 7/217
USPC 363/89

(57) ABSTRACT

A controller having adjustable frequency-reduction function for a power conversion application, comprising: a threshold voltage sampling unit, having a first node coupled to an external resistor network for generating a threshold voltage at the first node, which is then sampled by the threshold voltage sampling unit; a PWM unit having a second node for receiving a feedback voltage from a load, and a third node for providing a PWM signal of a switching frequency; and a driver unit for driving an external power transistor according to the PWM signal; wherein the switching frequency starts to decrease from a first frequency when the feedback voltage falls below a first threshold voltage, which is a first function of the threshold voltage.

### BACKGROUND OF THE INVENTION

1. Field of the Invention

The present invention relates to a controller for power conversion, especially to a controller having an adjustable frequency-reduction function to provide appropriate switching frequencies for different power conversion applications.

2. Description of the Related Art

As energy efficiency is more and more demanded globally, regulations for power supplies are becoming more and more stringent. Taking the California Energy Commission as an example, it proposed an efficiency level 4 regulation on Jul. 1, 2006, an efficiency level 5 regulation on Nov. 1, 2008, and an efficiency level 6 regulation—a DOE (Department of Energy) regulation—on Jul. 1, 2013. The required efficiency of a power supply has been continually pushed upward step by step. For example, a 12 W power supply is requested to have an efficiency of not less than 72.4% for the efficiency level 4, not less than 74.74% for the efficiency level 5, and not less than 79.94% for the efficiency level 6.

The change from the efficiency level 5 to the efficiency level 6 involves an efficiency improvement of 5.2%. As the components of general power supplies have been designed to have nearly approached their best efficiencies, it is very difficult for a power supply to meet the requirement of the efficiency level 6.

The power consumption of a power supply depends mostly on the switching frequency the power supply is operating at—the higher the switching frequency is, the larger the power consumption will be. To further improve the efficiency of a power supply, one solution utilizing a frequency-reduction mechanism has been proposed. The principle of the frequency-reduction mechanism is that—a controller of the power supply will reduce the switching frequency when a feedback voltage from a load falls below a preset threshold voltage, wherein the feedback voltage reflects the loading condition of the power supply in a way as follows: the feedback voltage will become lower when the loading becomes lighter, and will become higher when the loading becomes heavier.

However, as the preset threshold voltage is a fixed voltage and is generated inside the controller, different power conversion applications using the same controller will have different energy efficiency, and the efficiency level 6 is therefore still not attained.

To solve the foregoing problem, a novel controller is needed.

### SUMMARY OF THE INVENTION

One objective of the present invention is to disclose a controller having an adjustable frequency-reduction function for power conversion applications to reduce their power consumption.

Another objective of the present invention is to disclose a controller having an adjustable frequency-reduction function for power conversion applications to meet the requirement of the efficiency level 6.

Another objective of the present invention is to disclose a controller having an adjustable frequency-reduction function and being compatible with the existing structures of general power conversion systems.

Still another objective of the present invention is to disclose a controller having an adjustable frequency-reduction function to reduce the power consumption of general power conversion systems without interfering with the designs for safety regulation thereof.

To attain the foregoing objectives, a controller having an adjustable frequency-reduction function for a power conversion application is proposed, including:
a threshold voltage sampling unit, having a first node coupled to an external resistor network for generating a threshold voltage at the first node, which is then sampled by the threshold voltage sampling unit;
a PWM unit having a second node for receiving a feedback voltage from a load, and a third node for providing a PWM signal of a switching frequency; and
a driver unit for driving an external power transistor according to the PWM signal;
wherein the switching frequency starts to decrease from a first frequency when the feedback voltage falls below a first threshold voltage, the first threshold voltage being a first function of the threshold voltage.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a circuit diagram of a power converter using a controller of the present invention according to a preferred embodiment of the present invention.

FIG. 2 illustrates an arrangement of an operation frequency in response to a feedback voltage of the power converter of FIG. 1.

FIG. 3 illustrates a circuit diagram of a power converter using a controller of the present invention according to another preferred embodiment of the present invention.

### DETAILED DESCRIPTION OF THE PREFERRED EMBODIMENTS

The present invention will be described in more detail hereinafter with reference to the accompanying drawings that show the preferred embodiments of the invention.

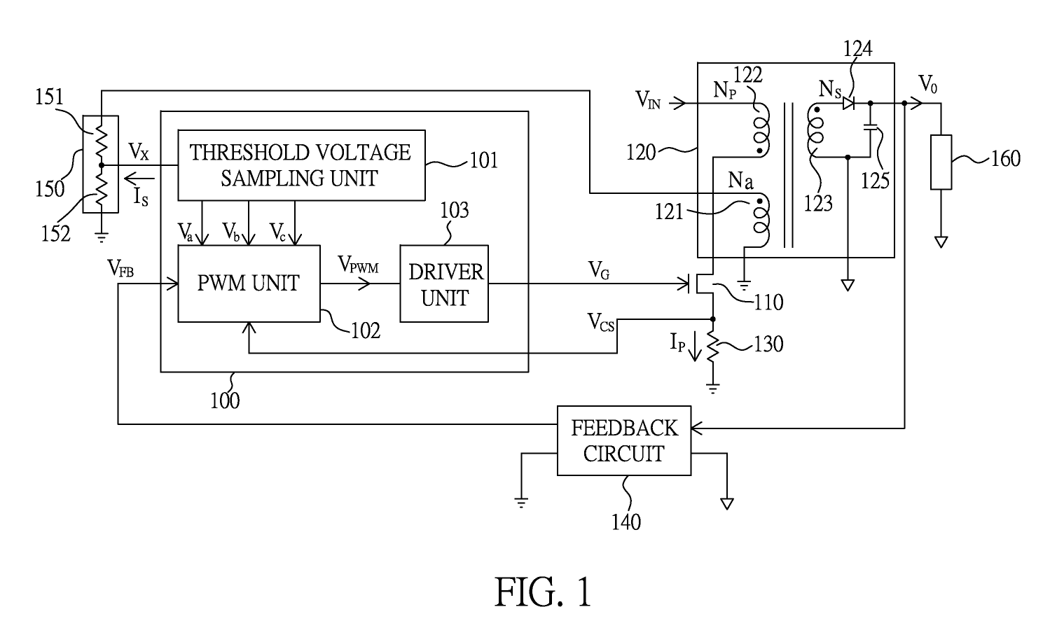

Please refer to FIG. 1, which illustrates a circuit diagram of a power converter using a controller of the present invention according to a preferred embodiment of the present invention. As illustrated in FIG. 1, a power converter includes a controller 100, a power transistor 110, a power transmission unit 120, a current sensing resistor 130, a feedback circuit 140, and a resistor network 150 for converting an input voltage V_{IN} to an output voltage V_{O} for a load 160.

The controller 100 includes a threshold voltage sampling unit 101, a PWM (pulse width modulation) unit 102, and a driver unit 103.

The threshold voltage sampling unit 101 has a first node coupled to the resistor network 150 for generating a threshold voltage V_{X} at the first node, which is then sampled by the threshold voltage sampling unit 101. The threshold voltage sampling unit 101 provides a constant current I_{S} when the power transistor 110 is on to generate the threshold voltage V_{X}, which is equal to −V_{IN}*(Nₐ/Nₚ)*R₂/(R₁+R₂)+I_{S}*R₂, wherein Nₐ is a turn number of an auxiliary coil 121 of the power transmission unit 120, Nₚ is a turn number of a primary coil 122 of the power transmission unit 120, R₁ is the resistance of a resistor 151 of the resistor network 150, and R₂ is the resistance of a resistor 152 of the resistor network 150. The threshold voltage sampling unit 101 generates a first threshold voltage Vₐ according to a first function of the threshold voltage V_{X}, a second threshold voltage V_{b} according to a second function of the threshold voltage V_{X}, and a third threshold voltage V_{c} according to a third function of the threshold voltage V_{X}, wherein Vₐ>V_{b}>V_{c}. The first function, the second function, and the third function are preferably but not limited to first order polynomial functions of V_{X}. For example, Vₐ can be equal to K₁*V_{X}+V_{dc1}, V_{b} can be equal to K₂*V_{X}+V_{dc2}, and V_{c} can be equal to K₃*V_{X}+V_{dc3}, wherein K₁, K₂, K₃, V_{dc1}, V_{dc2}, and V_{dc3} are constants.

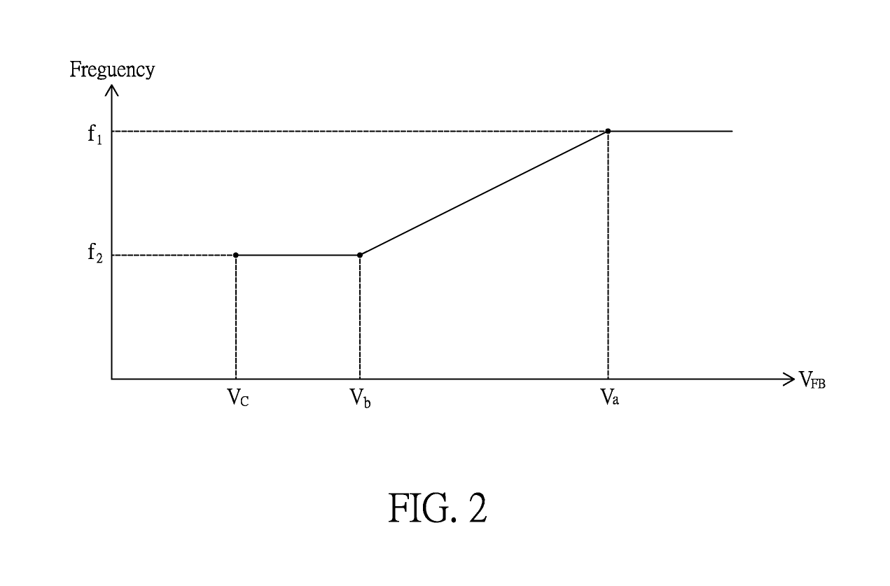

The PWM unit 102 has a second node for receiving a feedback voltage V_{FB} from the load 160 via the feedback circuit 140, a third node for providing a PWM signal V_{PWM} of a switching frequency, and a fourth node for receiving a current sensing signal V_{CS} from the current sensing resistor 130. The PWM unit 102 adjusts the duty of the PWM signal V_{PWM} in response to V_{FB} and V_{CS}, so as to generate the output voltage V_{O}. To reduce power consumption of the power converter, the PWM unit 102 adjusts the switching frequency of the PWM signal V_{PWM} in response to V_{FB} in a way as illustrated in FIG. 2 that: the switching frequency starts to decrease from a first frequency f₁ when the feedback voltage V_{FB} falls below the first threshold voltage Vₐ; the switching frequency stops decreasing and then remains at a second frequency f₂ when the feedback voltage V_{FB} falls below the second threshold voltage V_{b}; and when the feedback voltage V_{FB} falls below the third threshold voltage V_{c}, the PWM signal V_{PWM} enters a green mode. The green mode can be a burst mode or a skipping mode, in which the PWM signal V_{PWM} is active only once in a while.

The driver unit 103 is used for generating a driving signal V_{G} to drive the power transistor 110 according to the PWM signal V_{PWM}.

The power transistor 110, illustrated as an NMOS transistor in the figure though, can also be implemented with a bipolar transistor. The power transistor 110 is used to control a power transmission of the power transmission unit 120 from V_{IN} to the load 160.

The power transmission unit 120 includes the auxiliary coil 121, the primary coil 122, a secondary coil 123, a diode 124, and a capacitor 125 to transmit power from V_{IN} to the load 160 under the control of the power transistor 110. As the principle of the power transmission unit 120 is well known, it is not addressed here.

The current sensing resistor 130 is used to convert a primary current I_{P} to the current sensing signal V_{CS}.

The feedback circuit 140 is used to generate the feedback voltage V_{FB} according to a difference between the output voltage V_{O} and a reference voltage (not shown in the figure).

When the controller 100 is used in different power conversion applications, the resistance of the resistor 151 and the resistance of the resistor 152 can be adjusted to generate appropriate values of the threshold voltage V_{X} for the different power conversion applications, so as to meet the requirement of the efficiency level 6.

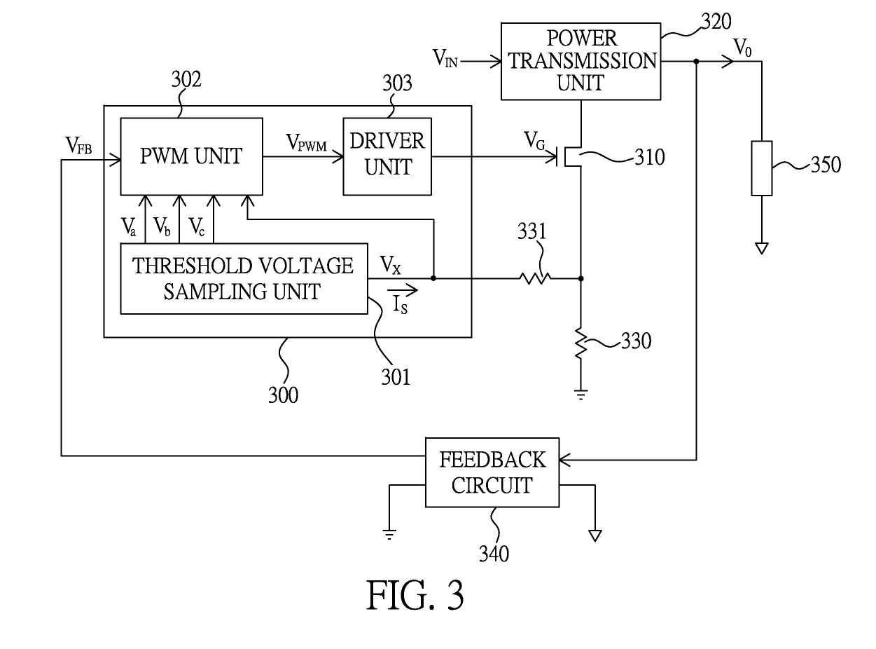

Based on the principle elaborated above, the present invention proposes another embodiment. Please refer to FIG. 3, which illustrates another embodiment of the controller of the present invention used in a power conversion application. As illustrated in FIG. 3, a power converter includes a controller 300, a power transistor 310, a power transmission unit 320, a first resistor 330, a second resistor 331, and a feedback circuit 340 for converting an input voltage V_{IN} to an output voltage V_{O} for a load 350.

The controller 300 includes a threshold voltage sampling unit 301, a PWM unit 302, and a driver unit 303.

The threshold voltage sampling unit 301 has a first node coupled to a resistor network consisting of the first resistor 330 and the second resistor 331 for generating a threshold voltage V_{X} at the first node, which is then sampled by the threshold voltage sampling unit 301. The threshold voltage sampling unit 301 provides a constant current I_{S} when the power transistor 310 is off to generate the threshold voltage V_{X}, which is equal to I_{S}*(R₁+R₂), wherein R₁ is the resistance of the first resistor 330, and R₂ is the resistance of the second resistor 331. The threshold voltage sampling unit 301 generates a first threshold voltage Vₐ according to a first function of the threshold voltage V_{X}, a second threshold voltage V_{b} according to a second function of the threshold voltage V_{X}, and a third threshold voltage V_{c} according to a third function of the threshold voltage V_{X}, wherein Vₐ>V_{b}>V_{c}. The first function, the second function, and the third function are preferably but not limited to first order polynomial functions of V_{X}. For example, Vₐ can be equal to K₁*V_{X}+V_{dc1}, V_{b} can be equal to K₂*V_{X}+V_{dc2}, and V_{c} can be equal to K₃*V_{X}+V_{dc3}, wherein K₁, K₂, K₃, V_{dc1}, V_{dc2}, and V_{dc3} are constants.

As the principles of the remaining parts have been described above with reference to FIG. 1, they will not be readdressed here.

With the designs elaborated above, the present invention possesses the following advantages:
1. The controller of the present invention is capable of providing an adjustable frequency-reduction function for power conversion applications to reduce power consumption.
2. The controller of the present invention is capable of making power conversion applications meet the requirement of the efficiency level 6.
3. The controller of the present invention is capable of providing an adjustable frequency-reduction function without changing the existing structures of general power conversion systems.
4. The controller of the present invention is capable of providing an adjustable frequency-reduction function to reduce the power consumption of general power conversion systems without interfering with the designs for safety regulation thereof.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A controller having adjustable frequency-reduction function for a power conversion application, comprising:
a threshold voltage sampling unit, having a first node coupled to an external resistor network for generating a threshold voltage at said first node, which is then sampled by said threshold voltage sampling unit;
a PWM unit having a second node for receiving a feedback voltage from a load, and a third node for providing a PWM signal of a switching frequency; and
a driver unit for driving an external power transistor according to said PWM signal;
wherein said switching frequency starts to decrease from a first frequency when said feedback voltage falls below a first threshold voltage, said first threshold voltage being a first function of said threshold voltage.

2. The controller having adjustable frequency-reduction function as disclosed in claim 1, wherein said switching frequency stops decreasing and then remains at a second frequency when said feedback voltage falls below a second threshold voltage, wherein said second threshold voltage is a second function of said threshold voltage and is lower than said first threshold voltage, and said second frequency is lower than said first frequency.

3. The controller having adjustable frequency-reduction function as disclosed in claim 2, wherein said PWM signal enters a green mode when said feedback voltage falls below a third threshold voltage, wherein said third threshold voltage is a third function of said threshold voltage and is lower than said second threshold voltage.

4. The controller having adjustable frequency-reduction function as disclosed in claim 1, wherein said power conversion application is an AC-to-DC converter.

5. The controller having adjustable frequency-reduction function as disclosed in claim 4, wherein said external resistor network has a first end coupled to an auxiliary coil of a transformer, a second end coupled to a ground, and a third end coupled to said first node of said threshold voltage sampling unit.

6. The controller having adjustable frequency-reduction function as disclosed in claim 4, wherein said external resistor network has a first end coupled to said first node of said threshold voltage sampling unit, a second end coupled to said external power transistor, and a third end coupled to a ground.

7. A system for a power conversion application, comprising:
a power transmission unit for transmitting power from an input voltage to a load under a control of a power transistor; and
a controller having adjustable frequency-reduction function, comprising:
a threshold voltage sampling unit, having a first node coupled to an external resistor network for generating a threshold voltage at said first node, which is then sampled by said threshold voltage sampling unit;
a PWM unit having a second node for receiving a feedback voltage from said load, and a third node for providing a PWM signal of a switching frequency; and
a driver unit for driving said power transistor according to said PWM signal;
wherein said switching frequency starts to decrease from a first frequency when said feedback voltage falls below a first threshold voltage, said first threshold voltage being a first function of said threshold voltage.

8. The system for a power conversion application as disclosed in claim 7, wherein said switching frequency stops decreasing and then remains at a second frequency when said feedback voltage falls below a second threshold voltage, wherein said second threshold voltage is a second function of said threshold voltage and is lower than said first threshold voltage.

9. The system for a power conversion application as disclosed in claim 8, wherein said PWM signal enters a burst mode when said feedback voltage falls below a third threshold voltage, wherein said third threshold voltage is a third function of said threshold voltage and is lower than said second threshold voltage.

10. The system for a power conversion application as disclosed in claim 7, wherein said power conversion application is an AC-to-DC converter.

11. The system for a power conversion application as disclosed in claim 10, wherein said external resistor network has a first end coupled to an auxiliary coil of a transformer of said power transmission unit, a second end coupled to a ground, and a third end coupled to said first node of said threshold voltage sampling unit.

12. The system for a power conversion application as disclosed in claim 10, wherein said external resistor network has a first end coupled to said first node of said threshold voltage sampling unit, a second end coupled to said power transistor, and a third end coupled to a ground.
